(19) United States
(12) Patent Application Publication
(10) Pub. No.: US 2003/0061750 A1
(43) Pub. Date: Apr. 3, 2003

(54) Label for pharmaceutical prescriptions

(75) Inventors: Daniel Bernier, Boisbriand (CA); Detlev Bilo, Mississauga (CA); Ted Ramsay, Burlington (CA)

Correspondence Address: SMART & BIGGAR, 1000 de la Gauchetiere Street West, Suite 3400, Montreal, QC, H3B4W5, CA

(73) Assignee: CAMEO GRAPHIC INDUSTRIES LIMITED

(21) Appl. No.: 09/969,823

(22) Filed: Oct. 4, 2001

(30) Foreign Application Priority Data
Oct. 3, 2001 (CA) 2,358,177

(51) Int. Cl. G09F 3/00; G09F 3/10

(52) U.S. Cl. 40/638; 40/310

(57) ABSTRACT

A two-ply laminated label comprises a top opaque ply having a printable front surface and a bottom transparent ply. The top ply of the label is superimposed on and removably adhered to the bottom ply, forming the laminated two-ply label. The bottom ply of the laminated label is superimposed on and removably adhered to a release liner, until label application. The two-ply laminated label is preferably adapted to be adhered to a pharmaceutical container. The top ply can be removed from the bottom ply which is permanently adhered to the container, in order to be permanently adhered to another surface, such as a physician's prescription pad.

### TECHNICAL FIELD

The present invention relates to labels, and more particularly, to a removable label for pharmaceutical products which can be permanently adhered to another surface.

### BACKGROUND OF THE INVENTION

The prescription of a pharmaceutical product for a short trial period is a widespread practice among medical practitioners. Many drugs can have significant side effects for some patients and absolutely none for others. As such, many doctors will prescribe a new pharmaceutical product to a patient for a trial period. If the patient does not exhibit any side effects and if the prescribed product has positive results, the doctor will write out a prescription renewal for the pharmacist.

This transcription, for the prescription renewal, of the specific details of the pharmaceutical product initially prescribed by the doctor has on several occasions proven to be problematic. Minor errors in transcribing the detailed information on the label of the pharmaceutical product bottle to the physician's prescription pad can result in significantly detrimental consequences for the patient.

Whether it is a well deserving generalization or not, the handwriting of physicians is notoriously poor, and as such many pharmacists often also have problems in clearly deciphering the hand-written prescriptions of some doctors. This can lead to serious errors being made in pharmaceutical products prescribed to patients, such as the wrong recommended dosage.

Some attempts have been made to provide labels intended for use on pharmaceutical bottles which have, for various reasons, removable portions which can be peeled off the label after it is adhered to a bottle.

U.S. Pat. No. 5,958,536, issued Sep. 28, 1999 to Gelsinger et al, discloses, for example, a self-adhesive label for a bottle, such as a pharmaceutical stock bottle, with a detachable sticker. The label comprises an adhesive layer superimposed on a release liner. The adhesive layer has an adhesive section and a detachable section, each of which has an adhesive backing. The detachable sections are instruction stickers which, when removed from the main label which is preferably adhered to a pharmacist's stock bottle, can be permanently adhered to the individual prescription bottles in which the medicine is dispensed to customers.

Various systems for simplifying the pharmaceutical prescription process are also known. For example, Canadian Patent 1,116,203, issued Jan. 12, 1982 to Lockart, discloses a pharmaceutical record and label system that is intended to simplify the job of the pharmacist and eliminate any possible errors between the drug prescribed and the record kept by the pharmacy. A backing sheet capable of storing information relative to pharmaceutical prescriptions having adhesively backed prescription label segments is removably secured thereto. Each label accommodates simultaneous transfer of typewriter impressions to the backing sheet.

However, there nevertheless remains a need for a system that permits the physician to quickly and easily create a prescription renewal that ensures that the details of the pharmaceutical product re-prescribed are correct and that the prescription is unambiguously clear for the prescribing pharmacist.

### SUMMARY OF THE INVENTION

It is an object of the present invention to provide a simple and error-free method for transferring details of a prescribed product in a pharmaceutical bottle to another surface, such as a physician's prescription pad.

It is an object of the present invention to provide an improved label for pharmaceutical bottles.

It is another object of the present invention to provide a self-adhesive two-ply label.

It is a further object of the present invention to provide a label that can be removed from the pharmaceutical bottle and permanently adhered to another object.

Therefore, according to the present invention, there is provided a two-ply label removably adhered to a release liner, said label comprising: a top opaque ply superimposed on a bottom transparent ply; said bottom transparent ply superimposed on the release liner, the release liner having a release coating on a front surface thereof; said top opaque ply having a printable front surface and having adhesive backing thereon; said bottom transparent ply having a release coating on a front surface and having adhesive backing thereon; said bottom transparent ply being removable from the release liner to be permanently adhered to a first surface; and said top opaque ply being removable from said bottom transparent ply to be permanently adhered to a second reference surface.

There is also provided a method for transferring a pharmaceutical product label from a pharmaceutical container to a second surface, comprising the steps of: providing a two-ply removably laminated label, comprising an opaque printed top ply superimposed on a bottom transparent ply, adhered to a pharmaceutical container; removing said top ply of said two-ply removably laminated label; and adhering said top ply to a reference surface.

According to the present invention, there is additionally provided a method for creating a pharmaceutical prescription, comprising the steps of: providing a pharmaceutical container; providing a two-ply removably laminated label, comprising an opaque printed top ply superimposed on a bottom transparent ply, removably adhered to a release liner; removing said two-ply removably laminated label from said release liner; adhering said two-ply removably laminated label to said pharmaceutical container; removing, at a later date, said top ply of said two-ply removably laminated label; and adhering said top ply to a physician's pharmaceutical prescription pad.

### BRIEF DESCRIPTION OF THE DRAWINGS

Further features and advantages of the present invention will become apparent from the following detailed description, taken in combination with the appended drawings, in which:

FIG. 1 is a perspective view of a label according to the present invention on a pharmaceutical bottle;

FIG. 2 is a top elevation view of the label shown in FIG. 1 on a release liner, before being adhered to a pharmaceutical bottle;

FIG. 3 is a side elevation view of the label shown in FIG. 2;

FIG. 4a is a perspective view of a label according to the present invention, with the top ply partially peeled away from the pharmaceutical bottle to which it is adhered;

FIG. 4b is a perspective view of the pharmaceutical bottle of FIG. 4a showing the top ply of the label completely removed; and

FIG. 4c is a top elevation view of a physician's prescription pad having the label removed from the pharmaceutical bottle of FIG. 4b adhered thereto.

### DETAILED DESCRIPTION OF THE PREFERRED EMBODIMENT

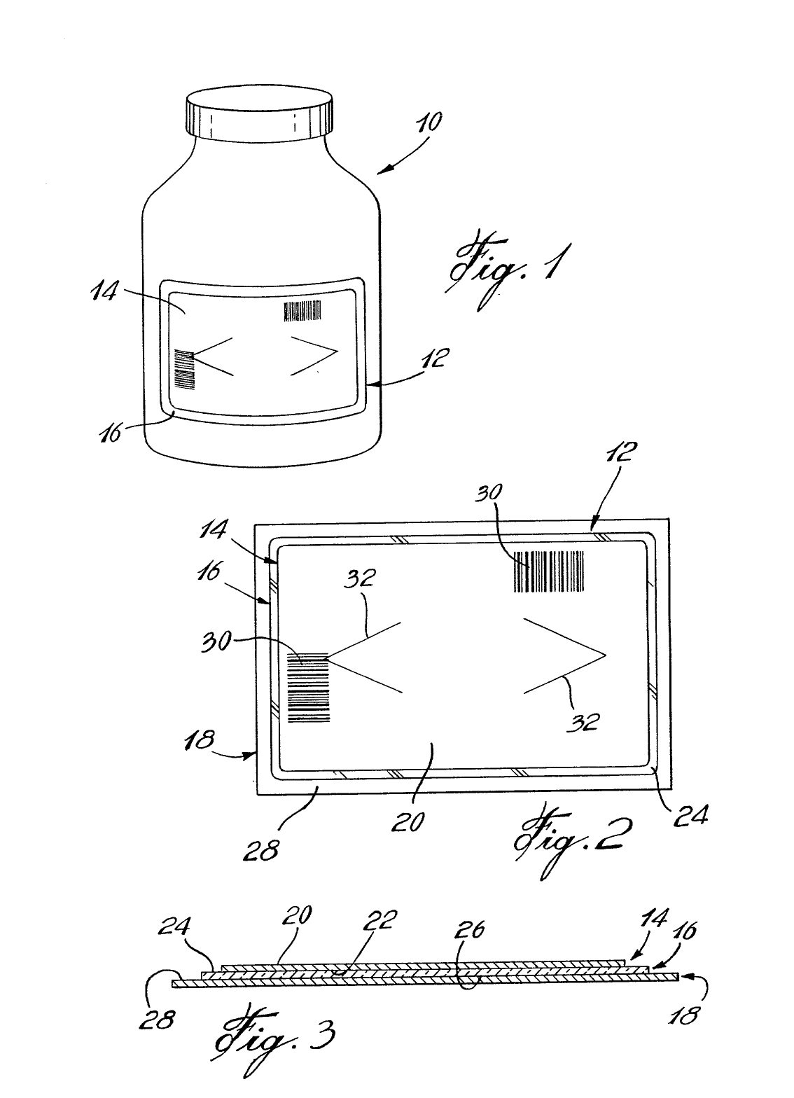

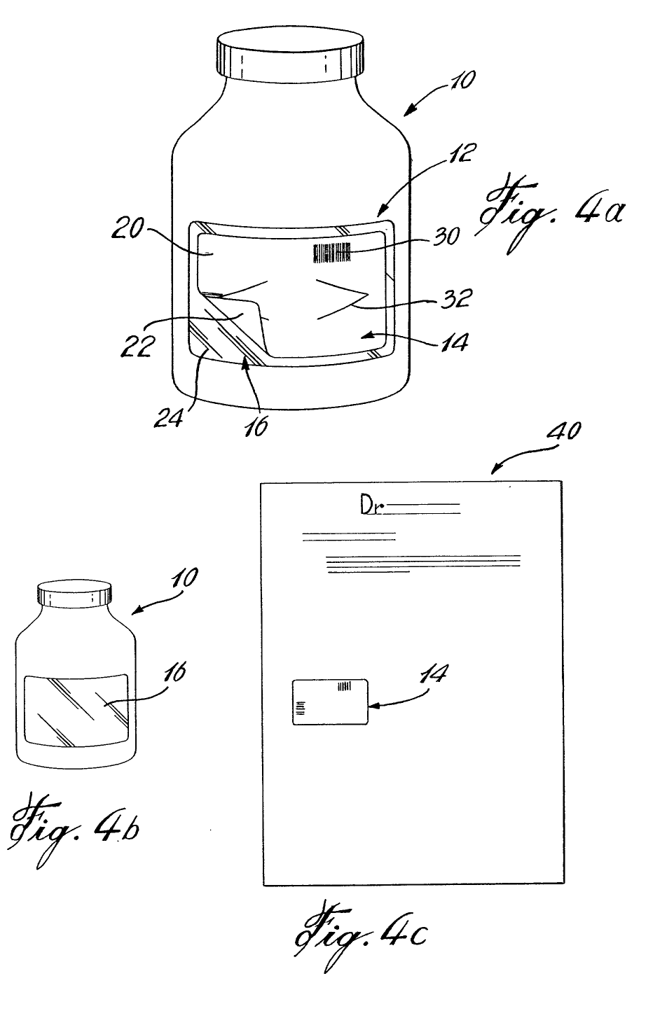

Referring first to FIG. 1, a laminated two-ply label assembly 12, shown applied to a pharmaceutical bottle 10, generally comprises a top ply 14 and a bottom ply 16.

Referring to FIGS. 2 and 3, the label 12 comprises a top opaque ply 14 and a bottom transparent ply 16, which are adhered to a release liner backing 18 until application. The top ply 14 is superimposed on and laminated to the bottom ply 16. The laminated two-ply label 12 is removed from the release liner backing 18, and permanently adhered to a pharmaceutical bottle 10. The top opaque ply 14 has a printable front surface 20 and a rear surface 22 having permanent adhesive applied thereto. The bottom transparent ply 16 has a front surface 24 and a rear surface 26. The front surface 24 has a release coating thereon that permits the top ply 14 to be removably adhered to the bottom ply. The rear surface 26 of the bottom ply 16 has permanent adhesive applied thereto, to secure the label to the pharmaceutical container. The front surface 28 of the release liner backing 18 has a release coating thereon similar to that of the front surface 24, that permits the bottom ply having permanent adhesive thereon to be removable from the backing 18.

After the front surface 20 of the top ply of the label has been printed with the necessary information, such as drug trade name and prescribed dosage, for example, the two-ply laminated label 12, comprising the bottom ply 16 and the superimposed top printed ply 14 adhesively secured thereto, can be peeled away from the release liner backing, which can be subsequently discarded, and adhered to the pharmaceutical bottle or product to be labelled. The permanent adhesive of the bottom ply then ensures that the label remains securely engaged to the product bottle, carton, or other container.

The printable opaque top ply 14 of the label 12 also comprises an identification means, such as scanable identification bar codes 30. These provide safety measures commonly used in the pharmaceutical industry to ensure that the applied label correctly identifies the pharmaceutical product in the labelled container. The consequences of mislabelling a pharmaceutical product are potentially disastrous. As another safety measure, security slits 32 are die-cut into the printable top ply 14 of the label. These slits 32 prevent the printed ply 14 from being removed intact from any surface, other than a surface having a release coating thereon, such as the front surface of the bottom ply, to which it is adhered.

The top ply 14 of the laminated label 12 can be peeled away in one piece from the bottom transparent ply 16, because of the release coating on the front surface 24 of the bottom ply 16. This permits the printed top ply 14 of the label to be permanently adhered to another surface after it has been removed from the bottom ply 16. As the bottom ply 16 that remains adhered to the original packaging is transparent, any information that is on the product carton or bottle remains easily visible.

When the laminated label 12 is adhered to the original pharmaceutical product packaging, it provides the necessary information regarding the drug contained therein for the duration of the prescription. When the patient returns to the physician to renew the prescription, the doctor simply has to peel away the top printed opaque ply 14, containing all the pertinent information about the drug prescribed, from the laminated label 12 fixed to the product, and adhere this printed top ply 14 directly to a page of a prescription pad 40. This eliminates any possible errors made by the physician in transcribing the information from the product bottle to a prescription pad if a prescription renewal is required. This also creates prescriptions that are neatly printed and unambiguous, eliminating the possibility of errors being made by pharmacists in deciphering a physician's handwriting.

The label material and the type of adhesive used can be chosen from a variety of materials and adhesives. In a sample of the preferred embodiment of the present invention, the top ply of the label was a bright white high gloss, coated litho, made and sold by Mactac as White Gold™ 65#, having a general purpose permanent rubber based adhesive thereon characterized by excellent tack and ultimate adhesive to a wide variety of surfaces, on an SCK, semi-bleached, super-calendered, sulfate kraft backing release liner, having excellent internal strength, toughness, and tear resistance. The bottom ply of the label was a 2.6 mil, Top Coated Clear Labelux made by JAC Canada Inc., having water based acrylic permanent adhesive E326 thereon, and a PP44 release liner.

Changes and modifications may be made by persons skilled in the art, without departing from the spirit and scope of the invention. While pharmaceutical bottles are shown and described, any container or packaging used commercially to contain prescription pharmaceutical products, such as cartons and boxes, for example, are equally applicable. The application of the invention is also not restricted to pharmaceutical products, but labels according to the present invention can equally be used for any other product requiring labelling. Although the label materials and adhesive of the preferred embodiment are as listed above, any other label materials and adhesives that enable the same operation are equally possible. The above description of the embodiment is for illustration of the invention only and is not intended to limit the scope of the invention, which is intended to be limited only by the scope of the appended claims.

We claim:

1. A two-ply laminated label removably adhered to a front surface of a release liner having a release coating thereon, said label comprising:
a top opaque ply superimposed on a bottom transparent ply;
said top opaque ply having a printable front surface and having adhesive backing thereon;
said bottom transparent ply having a release coating on a front surface and having adhesive backing thereon;
said bottom transparent ply being superimposed on the front surface of the release liner;
said two-ply laminated label being removable from the release liner to be permanently adhered to a first surface of an article; and
said top opaque ply being removable from said bottom transparent ply to be permanently adhered to a second reference surface.

2. The label as defined in claim 1, wherein said label is a pharmaceutical label.

3. The label as defined in claim 2, wherein said article including said first surface is a pharmaceutical container.

4. The label as defined in claim 1, wherein said second reference surface is a physician's prescription pad.

5. The label as defined in claim 1, wherein said second reference surface is a pharmacist's file.

6. The label as defined in claim 1, wherein said top opaque ply comprises die-cut safety slits defining tabs therein.

7. The label as defined in claim 6, wherein once said top opaque ply is adhered to said second reference surface, said tabs prevent said top opaque ply from being removed intact from said second reference surface.

8. The label as defined in claim 1, wherein said printable front surface of said top opaque ply comprises an identification code.

9. The label as defined in claim 8, wherein said identification code is a scanable bar code.

10. The label as defined in claim 3, wherein said pharmaceutical container is a pharmaceutical prescription bottle.

11. A method for transferring a pharmaceutical product label from a pharmaceutical container to a second surface, comprising the steps of:
providing a two-ply removably laminated label, comprising an opaque printed top ply superimposed on a bottom transparent ply, adhered to a pharmaceutical container;
removing said top ply of said two-ply removably laminated label; and
adhering said top ply to a reference surface.

12. A method for creating a pharmaceutical prescription, comprising the steps of:
providing a pharmaceutical container;
providing a two-ply removably laminated label, comprising an opaque printed top ply superimposed on a bottom transparent ply, removably adhered to a release liner;
removing said two-ply removably laminated label from said release liner;
adhering said two-ply removably laminated label to said pharmaceutical container;
removing, at a later date, said top ply of said two-ply removably laminated label; and
adhering said top ply to a physician's pharmaceutical prescription pad.
